(19) United States
(12) Patent Application Publication
(10) Pub. No.: US 2021/0192554 A1
(43) Pub. Date: Jun. 24, 2021

(54) METHOD, APPARATUS, DEVICE AND STORAGE MEDIUM FOR JUDGING PERMANENT AREA CHANGE

(71) Applicant: Beijing Baidu Netcom Science Technology Co., Ltd., Beijing (CN)

(72) Inventors: Yanyan LI, Beijing (CN); Jianguo DUAN, Beijing (CN); Hui XIONG, Beijing (CN)

(21) Appl. No.: 17/022,269

(22) Filed: Sep. 16, 2020

(30) Foreign Application Priority Data
Jan. 10, 2020 (CN) 202010027131.4

(51) Int. Cl. G06Q 30/02

(52) U.S. Cl. CPC G06Q 30/0205

(57) ABSTRACT

Embodiments of the present application provide a method, an apparatus, a device, and a storage medium for judging permanent area change, and relate to the field of computer technologies. By determining feature information corresponding to at least one candidate user, where any candidate user is a user whose permanent area changes with a probability greater than a first preset probability threshold, and furthermore, by inputting feature information corresponding to the above-mentioned at least one candidate user into a preset classification model, it can be judged whether a target permanent area of the above-mentioned at least one candidate user is changed.

### CROSS-REFERENCE TO RELATED APPLICATIONS

The present application claims priority to Chinese application number 202010027131.4, filed on Jan. 10, 2020, which is incorporated by reference in its entirety.

### TECHNICAL FIELD

The present application relates to the field of computer technologies and, in particular, to a method, an apparatus, a device, and a storage medium for judging permanent area change.

### BACKGROUND

In the era of mobile Internet, as an important feature to describe user offline behaviors, user permanent areas (such as home, company, etc.) are widely used in various personalized applications, e.g., information flow push, online advertising recommendation, video recommendation, travel map recommendation, car recommendation, takeout recommendation, etc. How to quickly discover change of a user's permanent area is critical for personalized application recommendations.

In the prior art, a user's permanent area is analyzed by clustering a large number of positioning points generated by the user within a specific period. Normally, the existing method requires a sufficient number of positioning points to analyze change of the user's permanent area, so that the existing method requires a long time to analyze the change of the user's permanent area.

Therefore, the prior art is poor in timeliness and accuracy.

### SUMMARY

Embodiments of the present application provide a method, an apparatus, a device, and a storage medium for judging permanent area change to solve the technical problem that the prior art is poor in timeliness and accuracy.

In a first aspect, an embodiment of the present application provides a method for judging permanent area change, including:

determining feature information corresponding to at least one candidate user; where the candidate user is a user whose permanent area changes with a probability greater than a first preset probability threshold, and the feature information corresponding to the candidate user includes: feature information of a first access behavior of the candidate user within a first preset duration, feature information of a second access behavior of the candidate user within a second preset duration, and spatio-temporal feature information of a new access area of the candidate user within the first preset duration; and inputting the feature information corresponding to the at least one candidate user into a preset classification model to judge whether a target permanent area of the at least one candidate user is changed.

In an embodiment of the present application, by determining feature information corresponding to at least one candidate user, where any candidate user is a user whose permanent area changes with a probability greater than a first preset probability threshold, and feature information corresponding to any candidate user may include but is not limited to: feature information of a first access behavior of the candidate user within a first preset duration, feature information of a second access behavior of the candidate user within a second preset duration, and spatio-temporal feature information of a new access area of the candidate user within the first preset duration; and furthermore, by inputting feature information corresponding to the above-mentioned at least one candidate user into a preset classification model, it can be judged whether a target permanent area of the above-mentioned at least one candidate user is changed. As such, in this embodiment of the present application, by inputting, into the trained preset classification model, the determined feature information corresponding to the at least one candidate user whose permanent area may change, it can be judged whether a target permanent area of the above-mentioned at least one candidate user is changed, and thus it is possible to discover the change of the permanent area of the user quickly and accurately.

In an implementation, the determining feature information corresponding to at least one candidate user includes:

for any said candidate user, determining the feature information of the first access behavior and the feature information of the second access behavior according to location positioning information of the candidate user; and

determining the spatio-temporal feature information according to the location positioning information of the candidate user, map information, and demographic information.

In an implementation, before the determining feature information corresponding to at least one candidate user, the method further includes:

determining a candidate set from an initial set based on probability distribution of a user accessing a permanent area; where the initial set includes: user information of multiple users and at least one piece of permanent area information corresponding to the user information, and the candidate set includes: user information of the at least one candidate user and at least one piece of permanent area information corresponding to the user information.

In an implementation, the determining a candidate set from an initial set based on probability distribution of a user accessing a permanent area includes:

for any permanent area of any user in the initial set, determining a preset duration threshold corresponding to the user according to the probability distribution of the user accessing the permanent area and a second preset probability threshold; and

when the user does not access the permanent area corresponding to the user within the preset duration threshold, storing user information of the user and permanent area information corresponding to the permanent area into the candidate set.

In an embodiment of the present application, by determining the above-mentioned candidate set from the above-mentioned initial set in time based on the probability distribution of the user accessing the permanent area, an electronic device can judge in time whether the permanent area of the above-mentioned at least one candidate user in the above-mentioned initial set is changed, thereby, it is advantageous for the above-mentioned electronic device to discover the change of the permanent area of the user quickly and accurately.

In an implementation, before the inputting the feature information corresponding to the at least one candidate user into a preset classification model to judge whether a permanent area of the at least one candidate user is changed, the method further includes:

acquiring training data; where the training data includes: feature information corresponding to multiple preset users, and indication information about whether a permanent area corresponding to the preset user is changed; and

inputting the training data into an initial classification model for training to obtain the preset classification model.

In an embodiment of the present application, the above-mentioned electronic device acquires training data, where the above-mentioned training data may include but is not limited to: feature information corresponding to multiple preset users, and indication information about whether a permanent area corresponding to each preset user is changed. Furthermore, the above-mentioned electronic device inputs the described training data into an initial classification model for training to obtain the described preset classification model, so that when feature information corresponding to the above-mentioned at least one candidate user is determined, the above-mentioned electronic device may input the feature information corresponding to the above-mentioned at least one candidate user into the trained preset classification model to judge whether the target permanent area of the above-mentioned at least one candidate user is changed. It can be seen that the embodiment of the present application can facilitate rapid and accurate discovery of change of the user's permanent area.

In an implementation, the feature information of the first access behavior includes at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or

the feature information of the second access behavior includes at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or

the spatio-temporal feature information includes at least one of the following: permanent population data of the new access area, a function category of the new access area, a number of points of interest POIs, and category distribution of the POIs.

In a second aspect, an embodiment of the present application provides an apparatus for judging permanent area change, including:

a first determining module, configured to determine feature information corresponding to at least one candidate user; where the candidate user is a user whose permanent area changes with a probability greater than a first preset probability threshold, and the feature information corresponding to the candidate user includes: feature information of a first access behavior of the candidate user within a first preset duration, feature information of a second access behavior of the candidate user within a second preset duration, and spatio-temporal feature information of a new access area of the candidate user within the first preset duration; and

a judging module, configured to input the feature information corresponding to the at least one candidate user into a preset classification model to judge whether a target permanent area of the at least one candidate user is changed.

In an implementation, the first determining module is specifically configured to:

for any said candidate user, determine the feature information of the first access behavior and the feature information of the second access behavior according to location positioning information of the candidate user; and

determine the spatio-temporal feature information according to the location positioning information of the candidate user, map information, and demographic information.

In an implementation, the apparatus further includes:

a second determining module, configured to determine a candidate set from an initial set based on probability distribution of a user accessing a permanent area; where the initial set includes: user information of multiple users and at least one piece of permanent area information corresponding to the user information, and the candidate set includes: user information of the at least one candidate user and at least one piece of permanent area information corresponding to the user information.

In an implementation, the second determining module is specifically configured to:

for any permanent area of any user in the initial set, determine a preset duration threshold corresponding to the user according to the probability distribution of the user accessing the permanent area and a second preset probability threshold; and

when the user does not access the permanent area corresponding to the user within the preset duration threshold, store user information of the user and permanent area information corresponding to the permanent area into the candidate set.

In an implementation, the apparatus further includes:

an acquiring module, configured to acquire training data; where the training data includes: feature information corresponding to multiple preset users, and indication information about whether a permanent area corresponding to the preset user is changed; and

a training module, configured to input the training data into an initial classification model for training to obtain the preset classification model.

In an implementation, the feature information of the first access behavior includes at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or

the feature information of the second access behavior includes at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or

the spatio-temporal feature information includes at least one of the following: permanent population data of the new access area, a function category of the new access area, a number of points of interest POIs, and category distribution of the POIs.

In a third aspect, an embodiment of the present application provides an electronic device, including:

at least one processor; and a memory communicatively connected to the at least one processor; where the memory is stored with instructions executable by the at least one processor, and the instructions are executed by the at least one processor to enable the at least one processor to execute the method as described in the first aspect or any implementation of the first aspect.

In a fourth aspect, an embodiment of the present application provides a non-transitory computer readable storage medium stored with computer instructions, where the computer instructions are configured to enable the computer to execute the method as described in the first aspect or any implementation of the first aspect.

In summary, embodiments of the present application have the following beneficial effects compared with the prior art.

According to the method, the apparatus, the device, and the storage medium for judging permanent area change provided in the embodiments of the present application, by determining feature information corresponding to at least one candidate user, where any candidate user is a user whose permanent area changes with a probability greater than a first preset probability threshold, and feature information corresponding to any candidate user may include but is not limited to: feature information of a first access behavior of the candidate user within a first preset duration, feature information of a second access behavior of the candidate user within a second preset duration, and spatio-temporal feature information of a new access area of the candidate user within the first preset duration, and furthermore, by inputting feature information corresponding to the above-mentioned at least one candidate user into a preset classification model, it can be judged whether a target permanent area of the above-mentioned at least one candidate user is changed. As such, in the embodiments of the present application, by inputting, into the trained preset classification model, the determined feature information corresponding to the at least one candidate user whose permanent area may change, it can be judged whether a target permanent area of the above-mentioned at least one candidate user is changed, and thus it is possible to discover the change of the permanent area of the user quickly and accurately.

Other effects possessed by the foregoing manners will be described below in conjunction with specific embodiments.

### BRIEF DESCRIPTION OF DRAWINGS

The drawings are used for better understanding of the present schemes, but do not constitute a limitation of this application. Among them:

FIG. 1 is a schematic diagram of an application scenario according to an embodiment of the present application;

FIG. 2 is a schematic diagram of area division according to an embodiment of the present application;

FIG. 3 is a schematic diagram of a function category of any area according to an embodiment of the present application;

FIG. 4 is a schematic flowchart of a method for judging permanent area change according to an embodiment of the present application;

FIG. 5 is a schematic flowchart of a method for judging permanent area change according to another embodiment of the present application;

FIG. 6 is a schematic diagram of a probability mass function of positioning points occurred for a user on the K-th day according to an embodiment of the present application;

FIG. 7 is a schematic flowchart of a method for judging permanent area change according to another embodiment of the present application;

FIG. 8 is a schematic structural diagram of an apparatus for judging permanent area change according to an embodiment of the present application; and

FIG. 9 is a block diagram of an electronic device for implementing the method for judging permanent area change according to an embodiment of the present application.

### DESCRIPTION OF EMBODIMENTS

The following describes exemplary embodiments of the present application with reference to the accompanying drawings, which includes various details of the embodiments of the present application to facilitate understanding. The described embodiments are merely exemplary. Therefore, persons of ordinary skill in the art should know that various changes and modifications can be made to the embodiments described herein without departing from the scope and spirit of the present application. Also, for clarity and conciseness, descriptions of well-known functions and structures are omitted in the following description.

First, an application scenario in an embodiment of the present application and part of terms involved will be explained.

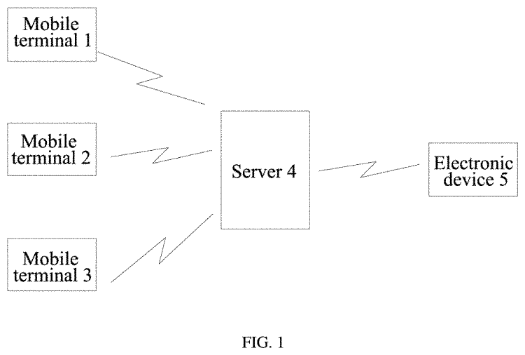

FIG. 1 is a schematic diagram of an application scenario according to an embodiment of the present application. As shown in FIG. 1, the application scenario in the embodiment of the present application may include but is not limited to: at least one mobile terminal (for convenience of description, an example is taken by using a mobile terminal 1, a mobile terminal 2, and a mobile terminal 3 in FIG. 1 for illustration), a server 4 and an electronic device 5.

A method for judging permanent area change provided in an embodiment of the present application may be applied to an electronic device. Exemplarily, the electronic device may include: a mobile phone, a tablet computer, a notebook computer, a desktop computer, or a server; of course, it may also include other devices with data processing functions, which is not limited in embodiments of the present application.

The mobile terminal involved in an embodiment of the present application may include: a mobile phone, a tablet computer or a notebook computer; of course, it may also include other mobile devices with functions of reporting location positioning information, which is not limited in embodiments of the present application.

Among them, the mobile terminal 1, the mobile terminal 2 and the mobile terminal 3 mentioned above are configured to upload respective location positioning information to the above-mentioned server 4 so that the above-mentioned server 4 stores the above-mentioned location positioning information.

The above-mentioned electronic device 5 is configured to acquire the location positioning information of the multiple mobile terminals from the above-mentioned server 4 and analyze the location positioning information of the above-mentioned multiple mobile terminals to determine user information of at least one candidate user and at least one piece of permanent area information corresponding to the user information; further, when feature information corresponding to the above-mentioned at least one candidate user is determined, the electronic device 5 may input the feature information corresponding to the above-mentioned at least one candidate user into a preset classification model to judge whether a target permanent area of the above-mentioned at least one candidate user is changed, so that it is possible to discover the change of the permanent area of the user quickly and accurately, thereby solving the technical problem that the prior art is poor in timeliness and accuracy.

A preset classification model involved in an embodiment of the present application refers to a classification model obtained by training an initial classification model using training data, where the preset classification model is configured to identify whether the permanent area of the user is changed.

Exemplarily, the initial classification model may include but is not limited to: a support vector machine model, a logistic regression model, a decision tree model, a neural network model, or a gradient boosting trees model.

In an embodiment of the present application, the above-mentioned electronic device 5 is preconfigured with a trained preset classification model. It should be understood that, if the above-mentioned electronic device 5 is a server, or the above-mentioned electronic device 5 is another device with a very powerful data processing capability other than the server, a training process of the above-mentioned preset classification model may be executed by the above-mentioned electronic device 5; if the above-mentioned electronic device 5 is another device with a limited data processing capability other than the server, a training process of the above-mentioned preset classification model may be executed by another server (for example, the above-mentioned server 4) connected to the above-mentioned electronic device 5, so that the above-mentioned electronic device 5 acquires the above-mentioned trained preset classification model from the server.

It should be noted that, in the following embodiments of the present application, introduction will be made to the training process of the above-mentioned preset classification model by taking an example where the above-mentioned electronic device 5 executes the training process of the above-mentioned preset classification model.

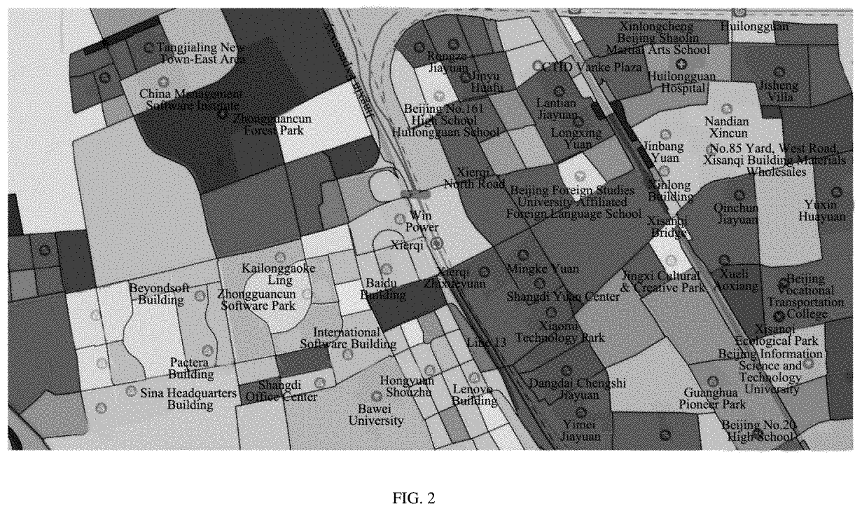

Any area involved in in an embodiment of the present application refers to a geographical area composed of one or more geographically adjacent sites. FIG. 2 is a schematic diagram of area division according to an embodiment of the present application. As shown in FIG. 2, FIG. 2 includes multiple areas, and each area includes one site or at least two adjacent sites.

A candidate user involved in an embodiment of the present application refer to a user whose permanent area changes with a probability greater than a first preset probability threshold, that is, a user whose permanent area may change.

A permanent area of any user involved in an embodiment of the present application refers to an area where the user often resides, for example, which may include but is not limited to: an area where home address belongs to, or an area where company address belongs to.

Information of any user involved in an embodiment of the present application may include but is not limited to: identification information of a mobile terminal of the user, and/or identification information of the user.

Information about a permanent area corresponding to any user involved in an embodiment of the present application may include but is not limited to: location coordinates of the permanent area, and/or information about a time during which the user accesses the permanent area.

Location positioning information of any user involved in an embodiment of the present application may include but is not limited to: identification information of the user, identification information of a mobile terminal of the user, at least one piece of location information uploaded by the user (such as location coordinates), and at least one piece of time information corresponding to each piece of location information.

Feature information of any user involved in an embodiment of the present application may include but is not limited to: feature information of a first access behavior of the user within a first preset duration, feature information of a second access behavior of the user within a second preset duration, and spatio-temporal feature information of a new access area of the user within the first preset duration, where the first preset duration is less than the second preset duration, for example, the first preset duration is 20 days, and the second preset duration is 90 days.

Feature information of a first access behavior of the above-mentioned user within a first preset duration involved in an embodiment of the present application is used to indicate feature information of a short-term access behavior of the user, and may include but is not limited to at least one of the following: a daily average number of positioning points of the user within the first preset duration, a number of positioning points of the user within each first preset time period (for example, 24 hours) in the first preset duration, a frequency at which the user accesses a further permanent area other than the target permanent area within the first preset duration, and a time during which the user accesses the further permanent area within the first preset duration.

It should be understood that a target permanent area of any candidate user involved in an embodiment of the present application refers to a permanent area that may change out of at least one permanent area of the candidate user (in order to distinguish it from other permanent areas, it is called the target permanent area).

Feature information of a second access behavior of the above-mentioned user in a second preset duration involved in an embodiment of the present application is used to indicate feature information of a long-term access behavior of the user, and may include but is not limited to at least one of the following: a daily average number of positioning points of the user within the second preset duration, a number of positioning points of the user within each second preset time period (for example, 24 hours) in the second preset duration, a frequency at which the user accesses each permanent area within the second preset duration, and a time during which the user accesses each permanent area within the second preset duration (or, a frequency at which the user accesses each permanent area per hour within the second preset duration).

Spatio-temporal feature information of a new access area of the above-mentioned user within the first preset duration involved in an embodiment of the present application may include but is not limited to at least one of the following: permanent population data of the new access area, a function category of the new access area, a number of points of interest (point of interest, POI), and category distribution of the POIs.

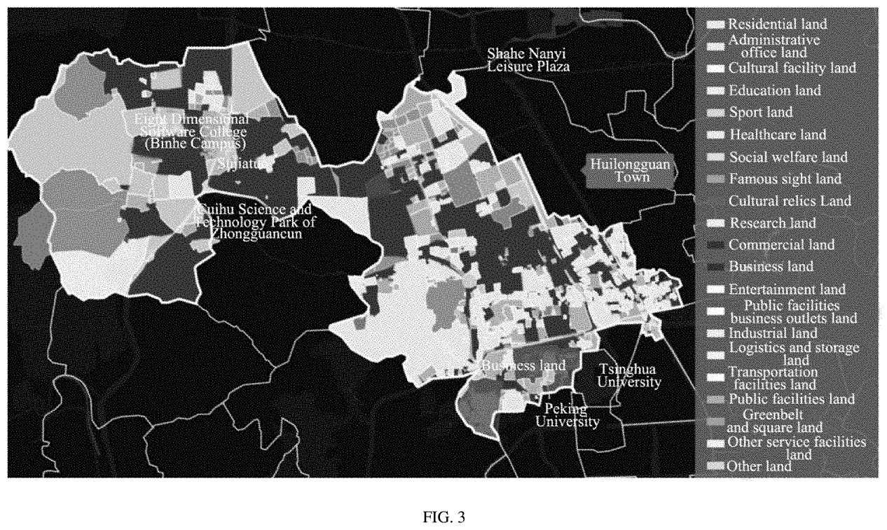

FIG. 3 is a schematic diagram of a function category of any area according to an embodiment of the present application. As shown in FIG. 3, the function category of any area involved in an embodiment of the present application may include but is not limited to at least one of the following: a residential category, an administrative office category, an education category, a famous sight category, a business category, and an entertainment category.

Technical solutions in the present application will be described in detail below with specific embodiments. The following specific embodiments may be combined with each other, and the same or similar concepts or processes may not be repeated in some embodiments.

FIG. 4 is a schematic flowchart of a method for judging permanent area change according to an embodiment of the present application. The execution subject of an embodiment of the present application may be the above-mentioned electronic device 5 or an apparatus for judging permanent area change in the above-mentioned electronic device 5 (for convenience of description, in this embodiment, description is made by taking an example where the execution subject is the above-mentioned electronic device 5). Exemplarily, the above-mentioned apparatus for judging permanent area change may be implemented by software and/or hardware.

As shown in FIG. 4, the method for judging permanent area change provided in this embodiment may include:

Step S401: determining feature information corresponding to at least one candidate user.

Any candidate user is a user whose permanent area changes with a probability greater than a first preset probability threshold, that is, a user whose permanent area may change.

Exemplarily, feature information corresponding to any candidate user may include but is not limited to: feature information of a first access behavior of the candidate user within a first preset duration, feature information of a second access behavior of the candidate user within a second preset duration, and spatio-temporal feature information of a new access area of the candidate user within the first preset duration, where the first preset duration is less than the second preset duration, for example, the first preset duration is 20 days, and the second preset duration is 90 days.

Exemplarily, feature information of a first access behavior of the above-mentioned candidate user within a first preset duration is used to indicate feature information of a short-term access behavior of the user, and may include but is not limited to at least one of the following: a daily average number of positioning points of the candidate user within the first preset duration, a number of positioning points of the candidate user within each first preset time period (for example, 24 hours) in the first preset duration, a frequency at which the candidate user accesses a further permanent area other than the target permanent area within the first preset duration, and a time during which the candidate user accesses the further permanent area within the first preset duration.

Exemplarily, feature information of a second access behavior of the above-mentioned candidate user in a second preset duration is used to indicate feature information of a long-term access behavior of the user, and may include but is not limited to at least one of the following: a daily average number of positioning points of the candidate user within the second preset duration, a number of positioning points of the candidate user within each second preset time period (for example, 24 hours) in the second preset duration, a frequency at which the candidate user accesses each permanent area within the second preset duration, and a time during which the candidate user accesses each permanent area within the second preset duration (or, a frequency at which the candidate user accesses each permanent area per hour within the second preset duration).

Exemplarily, spatio-temporal feature information of a new access area of the above-mentioned candidate user within the first preset duration may include but is not limited to at least one of the following: permanent population data of the new access area, a function category of the new access area, a number of points of interest POIs, and category distribution of the POIs. As shown in FIG. 3, the function category of the new access area may include but is not limited to at least one of the following: a residential category, an administrative office category, an education category, a famous sight category, a business category, and an entertainment category.

In this step, for any candidate user, the above-mentioned electronic device 5 may perform statistical analysis on the candidate user's location positioning information acquired from the above-mentioned server 4 to determine feature information of a first access behavior of the candidate user within a first preset duration and feature information of a second access behavior of the candidate user within a second preset duration, where the location positioning information of the candidate user may include but is not limited to: identification information of the candidate user, identification information of a mobile terminal of the candidate user, at least one piece of location information uploaded by the candidate user (such as location coordinates), and at least one piece of time information corresponding to each piece of location information.

It should be understood that the location positioning information of the candidate user includes at least location positioning information reported by the above-mentioned candidate user or a mobile terminal of the candidate user within the above-mentioned second preset duration, so that the above-mentioned electronic device 5 may determine feature information of a first access behavior of the candidate user within the first preset duration and feature information of a second access behavior of the candidate user within the second preset duration.

Furthermore, for any candidate user, the above-mentioned electronic device 5 may determine spatio-temporal feature information of a new access area of the candidate user within the first preset time period according to the location positioning information of the candidate user, map information, and demographic information.

Exemplarily, the above-mentioned electronic device 5 may perform statistical analysis on the location positioning information of the candidate user to determine a new access area of the candidate user within the first preset duration, and then perform statistical analysis according to map information and demographic information to determine spatio-temporal feature information of the new access area of the candidate user within the first preset duration, where the above-mentioned map information may include but is not limited to: a function category of the new access area, the number of POIs, and category distribution of the POIs; and the above-mentioned demographic information may include but is not limited to: permanent population data of the new access area.

Exemplarily, the above-mentioned electronic device 5 may acquire the above-mentioned map information through online query, or may acquire the above-mentioned map information from a map information management device; of course, the above-mentioned map information may also be acquired through other ways. This is not limited in embodiments of the present application.

Exemplarily, the above-mentioned electronic device 5 may acquire the above-mentioned demographic information through online query, or may acquire the above-mentioned demographic information from a demographic information management device; of course, the above-mentioned demographic information may also be acquired through other ways. This is not limited in embodiments of the present application.

Of course, the above-mentioned electronic device 5 may also determine the feature information corresponding to the above-mentioned at least one candidate user in other ways, which is not limited in embodiments of the present application.

Step S402: inputting the feature information corresponding to the at least one candidate user into a preset classification model to judge whether a target permanent area of the at least one candidate user is changed.

In an embodiment of the present application, the above-mentioned electronic device 5 is preconfigured with a trained preset classification model. It should be understood that, if the above-mentioned electronic device 5 is a server, or the above-mentioned electronic device 5 is another device with a very powerful data processing capability other than the server, a training process of the above-mentioned preset classification model may be executed by the above-mentioned electronic device 5; if the above-mentioned electronic device 5 is another device with a limited data processing capability other than the server, a training process of the above-mentioned preset classification model may be executed by another server (for example, the above-mentioned server 4) connected to the above-mentioned electronic device 5, so that the above-mentioned electronic device 5 acquires the above-mentioned trained preset classification model from the server.

In this step, the above-mentioned electronic device 5 uses the feature information corresponding to the above-mentioned at least one candidate user determined in above-mentioned Step S401 as input information of the above-mentioned preset classification model, inputs it into the preset classification model, and then operates the preset classification model to obtain output information of the preset classification model, where the output information is used to indicate whether the target permanent area of the above-mentioned at least one candidate user is changed.

Exemplarily, the above-mentioned electronic device 5 uses feature information xᵢ corresponding to the i-th candidate user of the above-mentioned at least one candidate user as input information of the above-mentioned preset classification model, inputs it into the preset classification model f(x₁, y₁), and then operates the preset classification model to obtain output information yᵢ of the preset classification model, where yᵢ is used to indicate whether the target permanent area of the above-mentioned i-th candidate user is changed; if yᵢ is equal to 0, it is used to indicate the target permanent area of the above-mentioned i-th candidate user has changed; if yᵢ is equal to 1, it is used to indicate that the target permanent area of the above-mentioned i-th candidate user has not changed; i runs over 1, 2, . . . , a total number M of the above-mentioned at least one candidate user, and M is an integer greater than 2.

It should be understood that the feature information xᵢ corresponding to the above-mentioned i-th candidate user may be a one-dimensional feature vector, and each column of the feature vector may be a certain piece of feature information in the feature information corresponding to the above-mentioned i-th candidate user, for example, a certain piece of feature information in feature information of a first access behavior of the i-th candidate user within a first preset duration, a certain piece of feature information in feature information of a second access behavior of the i-th candidate user within a second preset duration, or a certain piece of feature information in spatio-temporal feature information of a new access area of the i-th candidate user within the first preset duration.

For example, assuming that the feature information corresponding to the above-mentioned at least one candidate user includes: feature information x₁ corresponding to a candidate user 1, feature information x₂ corresponding to a candidate user 2, . . . , and feature information x_{M} corresponding to a candidate user M, the above-mentioned electronic device 5 inputs the feature information corresponding to the above-mentioned at least one candidate user as input information (x₁, x₂, . . . , x_{M}) of the above-mentioned preset classification model into the preset classification model f{(x₁, y₁), (x₂, y₂), . . . , (x_{M}, y_{M})}, and then operates the preset classification model to obtain output information (y₁, y₂, . . . , y_{M}) of the preset classification model, where y₁ is used to indicate whether the target permanent area of the above-mentioned candidate user 1 is changed, y₂ is used to indicate whether the target permanent area of the above-mentioned candidate user 2 is changed, and y_{M} is used to indicate whether the target permanent area of the above-mentioned candidate user M is changed.

In summary, in an embodiment of the present application, by determining feature information corresponding to at least one candidate user, where any candidate user is a user whose permanent area changes with a probability greater than a first preset probability threshold, and feature information corresponding to any candidate user may include but is not limited to: feature information of a first access behavior of the candidate user within a first preset duration, feature information of a second access behavior of the candidate user within a second preset duration, and spatio-temporal feature information of a new access area of the candidate user within the first preset duration, and furthermore, by inputting feature information corresponding to the above-mentioned at least one candidate user into a preset classification model, it can be judged whether a target permanent area of the above-mentioned at least one candidate user is changed. As such, compared with the method in the prior art according to which a user's permanent area is analyzed by clustering a large number of positioning points generated by the user in a specific period, in this embodiment of the present application, by inputting, into the trained preset classification model, the determined feature information corresponding to the at least one candidate user whose permanent area may change, it can be judged whether a target permanent area of the above-mentioned at least one candidate user is changed, and thus it is possible to discover the change of the permanent area of the user quickly and accurately.

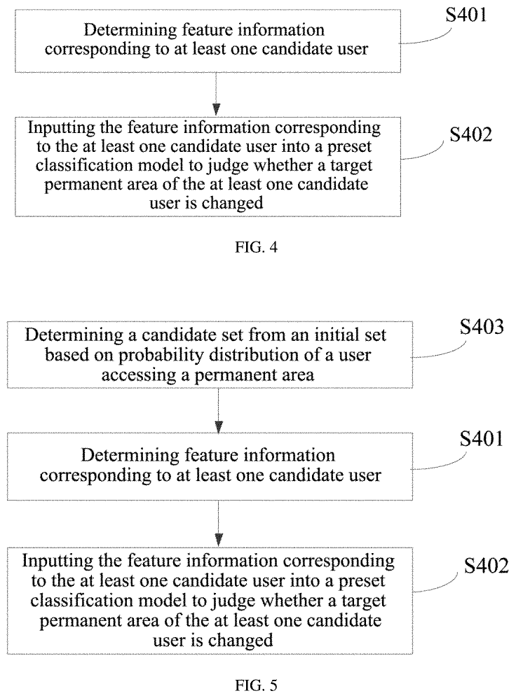

FIG. 5 is a schematic flowchart of a method for judging permanent area change according to another embodiment of the present application. On the basis of the foregoing embodiments, in an embodiment of the present application, introduction is made to an implementation according to which the electronic device 5 determines the candidate set. As shown in FIG. 5, in this embodiment, before the above-mentioned electronic device 5 performs the above-mentioned Step S401, further included is:

Step S403: determining a candidate set from an initial set based on probability distribution of a user accessing a permanent area.

In order to facilitate understanding, the following embodiments of the present application introduce the above-mentioned probability distribution of the user accessing the permanent area:

In an embodiment of the present application, the above-mentioned electronic device may acquire location positioning information of multiple mobile terminals from the above-mentioned server 4, where location positioning information of each mobile terminal may include but is not limited to: identification information of the mobile terminal, identification information of a user corresponding to the mobile terminal, at least one piece of location information (such as, location coordinates) uploaded by the mobile terminal, and at least one piece of time information corresponding to each piece of location information.

In an embodiment of the present application, according to the above-mentioned location information and time information of any user, the above-mentioned electronic device may obtain a sequence of access positioning points (locₜ_{₀}, locₜ_{₁}, locₜ_{₂}, . . . , locₜ_{_{T}},) of the user, where loc represents location information of the user, tₘ represents time information, m runs over 0, 1, 2, . . . , T′, and T′ is an integer greater than 2.

Furthermore, according to the above-mentioned sequence of access positioning points of the user, the above-mentioned electronic device may obtain a sequence of access areas (region1ₜ_{₀}, region2ₜ_{₁}, region3t₂, . . . , regionkₜ_{_{T}},) of the user, where region r represents an access area r of the user, r runs over 1, 2, . . . , R, and R is an integer greater than 2.

Furthermore, according to the above-mentioned sequence of access areas of the user, the above-mentioned electronic device may obtain a sequence of the user accessing each permanent area. For example, according to the above-mentioned sequence of access areas of the user, the above-mentioned electronic device may obtain a sequence of time (d₀, d₁, d₂, . . . , d_{D}) during which the user accesses a certain permanent area, where dₛ represents the time during which the user accesses the target permanent area, s runs over 0, 1, 2, . . . , D, and D is an integer greater than 2.

Furthermore, according to the above-mentioned sequence of time during which the user accesses the permanent area, the above-mentioned electronic device may obtain a sequence of whether the user accessing the permanent area in each day within a statistical period. Exemplarily, the above-mentioned electronic device 5 subtracts, according to an order from front to back, elements in the above-mentioned sequence of time during which the user accesses the permanent area: subtracts a second element and a first element, subtracts a third element and a second element, . . . , subtracts a D+1-th element and a D-th element, to obtain the sequence of whether the user accessing the permanent area in each day within the above-mentioned statistical period, for example (0, 1, 0, 0, 1, 1, 1, . . . , 1), where 1 indicates that the user accesses the permanent area on that day, and 0 indicates that the user did not access the permanent area on that day.

It should be noted that all of the sequences of whether any user accessing any permanent area in each day within a statistical period involved in an embodiment of the present application conforms to geometric distribution (or known as probability distribution of a user accessing a permanent area, or probability distribution of any user accessing any permanent area). Among them, the probability distribution of any user accessing any permanent area can be understood as probability distribution that the user successfully accesses the permanent area for the first time till the k-th time: P(k)=(1−p)^{k-1}*p

where p is used to indicate a probability of occurrence of the user's positioning point in the permanent area, p=num/T, T is used to indicate a statistical period, and num is used to indicate a number of days of occurrence of the user's positioning point in the permanent area within the statistical period.

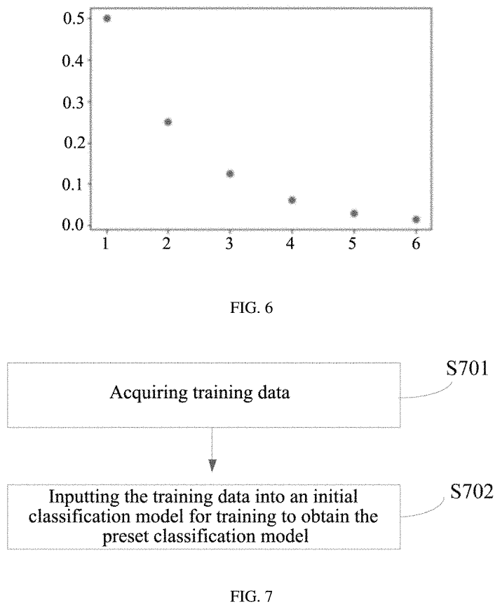

For example, FIG. 6 is a schematic diagram of a probability mass function of positioning points occurred for a user on the K-th day according to an embodiment of the present application. Assuming that the statistical period is 90 days and the number of days of occurrence of the user's positioning point in the permanent area is 45, p=0.5, then the probability mass function of occurrence of the user's positioning points in the permanent area on the K-th day is shown in FIG. 6, where the probability of occurrence of the user's positioning point in the permanent area on the second day is about 0.25, and the probability of occurrence of the user's positioning point in the permanent area on the fourth day is about 0.06.

In this step, the above-mentioned electronic device 5 determines a candidate set from an initial set based on the above-mentioned probability distribution of the user accessing the permanent area, where the initial set includes: user information of multiple users and at least one piece of permanent area information corresponding to the user information, and the candidate set includes: user information of the above-mentioned at least one candidate user and at least one piece of permanent area information corresponding to the user information.

It should be understood that the above-mentioned at least one piece of permanent area information corresponding to the user information of any candidate user may include but is not limited to: location coordinates of a target permanent area of the candidate user, and/or, time information of the user accessing the target permanent area.

It should be understood that the above-mentioned electronic device 5 may perform statistical analysis on the multiple mobile terminals' location positioning information acquired from the above-mentioned server 4 to determine the above-mentioned initial set in time, so that the above-mentioned electronic device 5 can judge in time whether the permanent area of the above-mentioned at least one candidate user in the above-mentioned initial set is changed.

Exemplarily, for any permanent area of any user in the above-mentioned initial set, the above-mentioned electronic device 5 may determine a preset duration threshold corresponding to the user according to the probability distribution of the user accessing the permanent area and a second preset probability threshold. Furthermore, when the user does not access the permanent area corresponding to the user within the preset duration threshold, the above-mentioned electronic device 5 may store user information of the user and permanent area information corresponding to the permanent area into the candidate set.

In an embodiment of the present application, for any permanent area of any user in the above-mentioned initial set, the above-mentioned electronic device 5 may determine the preset duration threshold corresponding to the user (that is, a maximum value of k, for example 10 days) in a manner that the probability distribution of the user accessing the permanent area P(k) is less than the second preset probability threshold (for example, 0.1).

Assuming that a previous time during which the user accesses the permanent area occurs in 2019.11.2, if the user has not accessed the permanent area corresponding to the user by 2019.11.2+10 days (for example, 2019.11.12), the above-mentioned electronic device 5 may consider that the permanent area of the user may be changed, and thus store the user information of the user and the permanent area information corresponding to the permanent area into the candidate set.

Of course, the above-mentioned electronic device 5 may determine the candidate set from the initial set in other ways than based on the above-mentioned probability distribution of user accessing the permanent area, which is not limited in embodiments of the present application.

In summary, in an embodiment of the present application, the above-mentioned electronic device 5 can determine the above-mentioned candidate set from the above-mentioned initial set in time based on the probability distribution of the user accessing the permanent area, so that the above-mentioned electronic device 5 can judge in time whether the permanent area of the above-mentioned at least one candidate user in the above-mentioned initial set is changed, thereby, it is advantageous for the above-mentioned electronic device 5 to discover the change of the permanent area of the user quickly and accurately.

FIG. 7 is a schematic flowchart of a method for judging permanent area change according to another embodiment of the present application. On the basis of the foregoing embodiments, in an embodiment of the present application, an introduction is made to an implementation according to which the above-mentioned electronic device 5 trains the above-mentioned preset classification model. As shown in FIG. 7, the method for judging permanent area change provided in an embodiment of the present application may include:

Step S701: acquiring training data.

The above-mentioned training data may include but is not limited to: feature information corresponding to multiple preset users, and indication information about whether a permanent area corresponding to each of the preset users is changed. For example, the above-mentioned training data may include {(x₁, y₁), (x₂, y₂), . . . , (x_{N}, y_{N})}, where xⱼ represents feature information corresponding to the j-th preset user in the above-mentioned multiple preset users, represents indication information about whether a permanent area corresponding to the above-mentioned j-th preset user is changed. If yⱼ is equal to 0, it is used to indicate that the permanent area corresponding to the above-mentioned j-th preset user has changed; if yⱼ is equal to 1, it is used to indicate that the permanent area corresponding to the above-mentioned j-th preset user has not changed; j runs over 1, 2, . . . , a total number of the above-mentioned multiple preset users N, and N is an integer greater than 2.

It should be understood that the feature information xⱼ corresponding to the j-th preset user may be a one-dimensional feature vector, and each column of the feature vector may be a certain piece of feature information in the feature information corresponding to the above-mentioned j-th preset user, for example, a certain piece of feature information in feature information of a first access behavior of the j-th preset user within a first preset duration, a certain piece of feature information in feature information of a second access behavior of the j-th preset user within a second preset duration, or a certain piece of feature information in spatio-temporal feature information of a new access area of the j-th preset user within the first preset duration.

In a possible implementation, the above-mentioned electronic device 5 may collect the above-mentioned training data through manual labeling or data crowdsourcing.

In another possible implementation, the above-mentioned electronic device 5 may collect the above-mentioned training data through data mining or the like.

Of course, the above-mentioned electronic device 5 may also acquire the above-mentioned training data in other ways, which is not limited in embodiments of the present application.

Step S702: inputting the training data into an initial classification model for training to obtain the preset classification model.

In this step, the above-mentioned electronic device 5 may input the above-mentioned training data {(x₁, y₁), (x₂, y₂), . . . , (x_{N}, y_{N})} acquired in the above-mentioned Step S701 into the initial classification model for training to obtain the above-mentioned preset classification model.

Exemplarily, the above-mentioned initial classification model may include but is not limited to: a support vector machine model, a logistic regression model, a decision tree model, a neural network model, or a gradient boosting trees model.

Exemplarily, the above-mentioned electronic device 5 may train the above-mentioned initial classification model according to the feature information xⱼ corresponding to the j-th preset user in the above-mentioned training data until the trained output information about whether the permanent area corresponding to the above-mentioned j-th preset user is changed matches the indication information yⱼ about whether the permanent area corresponding to the above-mentioned j-th preset user is changed, so as to obtain the above-mentioned preset classification model.

It should be understood that when the above-mentioned electronic device 5 trains the above-mentioned initial classification model according to the above-mentioned training data, there is no need that the training should stop under a circumstance where output information about whether a permanent area corresponding to each preset user is changed matches indication information about whether the permanent area corresponding to the preset user is changed, or under a circumstance where output information about whether permanent areas corresponding to preset users that meet a certain number of ratios are changed matches indication information about whether the permanent areas corresponding to the preset users are changed.

In an embodiment of the present application, the above-mentioned electronic device 5 acquires training data, where the above-mentioned training data may include but is not limited to: feature information corresponding to multiple preset users, and indication information about whether a permanent area corresponding to each of the preset users is changed. Furthermore, the above-mentioned electronic device inputs the above-mentioned training data into an initial classification model for training to obtain the preset classification model, so that when feature information corresponding to the above-mentioned at least one candidate user is determined, the above-mentioned electronic device 5 may input the feature information corresponding to the above-mentioned at least one candidate user into the above-mentioned trained preset classification model to judge whether the target permanent area of the above-mentioned at least one candidate user is changed. It can be seen that the embodiments of the present application can facilitate rapid and accurate discovery of the change of the user's permanent area.

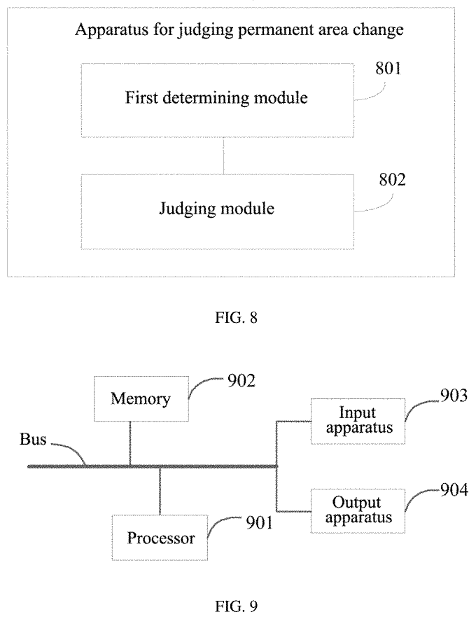

FIG. 8 is a schematic structural diagram of an apparatus for judging permanent area change according to an embodiment of the present application. As shown in FIG. 8, the apparatus 80 for judging permanent area change provided in an embodiment of the present application may include: a first determining module 801 and a judging module 802.

Among them, the first determining module 801 is configured to determine feature information corresponding to at least one candidate user; where the candidate user is a user whose permanent area changes with a probability greater than a first preset probability threshold, and the feature information corresponding to the candidate user includes: feature information of a first access behavior of the candidate user within a first preset duration, feature information of a second access behavior of the candidate user within a second preset duration, and spatio-temporal feature information of a new access area of the candidate user within the first preset duration; and

the judging module 802 is configured to input the feature information corresponding to the at least one candidate user into a preset classification model to judge whether a target permanent area of the at least one candidate user is changed.

In a possible implementation, the first determining module 801 is specifically configured to:

for any said candidate user, determine the feature information of the first access behavior and the feature information of the second access behavior according to location positioning information of the candidate user; and

determine the spatio-temporal feature information according to the location positioning information of the candidate user, map information, and demographic information.

In a possible implementation, the apparatus 80 further includes:

a second determining module, configured to determine a candidate set from an initial set based on probability distribution of a user accessing a permanent area; where the initial set includes: user information of multiple users and at least one piece of permanent area information corresponding to the user information, and the candidate set includes: user information of the at least one candidate user and at least one piece of permanent area information corresponding to the user information.

In a possible implementation, the second determining module is specifically configured to:

for any permanent area of any user in the initial set, determine a preset duration threshold corresponding to the user according to the probability distribution of the user accessing the permanent area and a second preset probability threshold; and

when the user does not access the permanent area corresponding to the user within the preset duration threshold, store user information of the user and permanent area information corresponding to the permanent area into the candidate set.

In a possible implementation, the apparatus 80 further includes:

an acquiring module, configured to acquire training data; where the training data includes: feature information corresponding to multiple preset users, and indication information about whether a permanent area corresponding to the preset user is changed; and

a training module, configured to input the training data into an initial classification model for training to obtain the preset classification model.

In a possible implementation, the feature information of the first access behavior includes at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or

the feature information of the second access behavior includes at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or

the spatio-temporal feature information includes at least one of the following: permanent population data of the new access area, a function category of the new access area, a number of points of interest POI, and category distribution of the POIs.

The apparatus 80 for judging permanent area change provided in this embodiment is configured to execute the technical solutions in the above-mentioned embodiments of the method for judging permanent area change of the present application, and their technical principles and technical effects are similar and will not be repeated here.

According to an embodiment of the present application, the present application further provides an electronic device and a readable storage medium.

As shown in FIG. 9, it is a block diagram of an electronic device for a method for judging permanent area change according to an embodiment of the present application. The electronic device is intended to represent various forms of digital computers, such as a laptop computer, a desktop computer, a workbench, a personal digital assistant, a server, a blade server, a mainframe computer, and other suitable computers. The electronic device can also represent various forms of mobile apparatus, such as a personal digital processing assistant, a cellular phone, a smart phone, a wearable device, and other similar computing apparatus. The components, their connections and relationships, and their functions herein are merely examples, and are not intended to limit an implementation of the application described and/or claimed herein.

As shown in FIG. 9, the electronic device includes: one or more processors 901, memories 902, and interfaces for connecting various components, including high-speed interfaces and low-speed interfaces. The components are connected to each other with different buses and can be installed on a common main board or in other ways as needed. The processor may process instructions executed within the electronic device, including instructions stored in or on the memory to display graphical information of GUI on an external input/output apparatus (such as a display device coupled to the interface). In other embodiments, if required, multiple processors and/or buses can be used with multiple memories. Similarly, multiple electronic devices can be connected, and each device provides some necessary operations (for example, as a server array, a group of blade servers, or a multi-processor system). In FIG. 9, one processor 901 is taken as an example.

The memory 902 is a non-transitory computer readable storage medium according to the present application. The memory is stored with instructions executable by at least one processor, so that the at least one processor executes the method for judging permanent area change according to the present application. The non-transitory computer readable storage medium of the present application is stored with computer instructions, the computer instructions are configured to enable a computer to execute the method for judging permanent area change according to the present application.

The memory 902 acting as a non-transitory computer-readable storage medium can be used to store a non-transitory software program, a non-transitory computer executable program and module, such as program instructions/a module corresponding to the method for judging permanent area change in the embodiments of the present application (For example, a first determining module 801 and the judging module 802 shown in FIG. 8). The processor 901 executes various functional applications and data processing by running the non-transitory software program, the instructions, and the module stored in the memory 902, that is, implementing the method for judging permanent area change in the foregoing method embodiments.

The memory 902 may include a program storage area and a data storage area, where the program storage area may be stored with an application program required by an operating system and at least one function; the data storage area may be stored with data created according to the use of the electronic device described above, and so on. In addition, the memory 902 may include a high-speed random access memory or a non-transitory memory, such as at least one magnetic disk storage device, a flash memory device, or other non-transitory solid-state storage devices. In some embodiments, the memory 902 includes memories remotely provided with respect to the processor 901, and these remote memories may be connected to the above electronic device through a network. Examples of the above network include, but are not limited to, Internet, an intranet, a local area network, a mobile communication network, and a combination of them.

The electronic device for the method for judging permanent area change may further include: an input apparatus 903 and an output apparatus 904. The processor 901, the memory 902, the input apparatus 903, and the output apparatus 904 may be connected through a bus or in other ways. In FIG. 9, connection through a bus is used as an example.

The input apparatus 903 can receive input digital or character information, and generate a key signal input related to user settings and function control of the above electronic device, such as a touch screen, a keypad, a mouse, a track pad, a touch panel, an indicator stick, one or more mouse buttons, a trackball, a joystick and other input apparatus. The output apparatus 904 may include a display device, an auxiliary lighting apparatus (such as an LED), a tactile feedback apparatus (such as a vibration motor), and so on. The display device may include, but is not limited to, a liquid crystal display (LCD), a light emitting diode (LED) display, and a plasma display. In some embodiments, the display device may be a touch screen.

Various embodiments of the systems and techniques described herein may be implemented in a digital electronic circuitry, an integrated circuit system, a special-purpose ASIC (application-specific integrated circuit), computer hardware, firmware, software, and/or a combination of them. These various embodiments may include: implementations in one or more computer programs which may be executed and/or interpreted on a programmable system including at least one programmable processor. The programmable processor may be a special-purpose or general programmable processor, and may receive data and instructions from a storage system, at least one input apparatus, and at least one output apparatus, and transmit the data and instructions to the storage system, the at least one input apparatus, and the at least one output apparatus.

These computer programs (also known as programs, software, software applications, or codes) include machine instructions of the programmable processor, moreover, these computer programs may be implemented with a high-level process and/or an object-oriented programming language, and/or an assembly/machine language. As used herein, the terms “machine-readable medium” and “computer-readable medium” refer to any computer program product, device, and/or apparatus (for example, a magnetic disk, an optical disk, a memory, a programmable logic device (PLD)) used to provide machine instructions and/or data to the programmable processor, including the machine-readable medium that receives machine instructions as a machine-readable signal. The term “machine-readable signal” refers to any signal used to provide the machine instructions and/or data to the programmable processor.

In order to provide interaction with users, the systems and techniques described herein may be implemented on a computer, where the computer has: a display apparatus (for example, a CRT (cathode ray tube) or an LCD (liquid crystal display) monitor) for displaying information to users; and a keyboard and a pointing apparatus (for example, a mouse or a trackball) though which users may provide input to the computer. Other types of apparatus may also be used to: provide interaction with users; for example, the feedback provided to users may be any form of sensing feedback (for example, visual feedback, audible feedback, or tactile feedback); and the input from users may be received in any form (including sound input, voice input, or tactile input).

The systems and techniques described herein may be implemented in a computing system that includes a back end component (for example, a data server), or a computing system that includes a middleware component (for example, an application server), or a computing system that includes a front end component (for example, a user computer with a graphical user interface or a web browser, through which the user can interact with the implementations of the systems and techniques described herein), or a computing system that includes any combination of such back end component, middleware component, or front end component. System components may be connected to each other by any form or medium of digital data communication (for example, a communication network). Examples of the communication network include: a local area network (LAN), a wide area network (WAN), and Internet.

A computing system may include a client and a server. The client and the server are generally far from each other and usually perform interactions through a communication network. A relationship between the client and the server is generated by a computer program running on a corresponding computer and having a client-server relationship.

According to the technical solutions in embodiments of the present application, by determining feature information corresponding to at least one candidate user, where any candidate user is a user whose permanent area changes with a probability greater than a first preset probability threshold, and feature information corresponding to any candidate user may include but is not limited to: feature information of a first access behavior of the candidate user within a first preset duration, feature information of a second access behavior of the candidate user within a second preset duration, and spatio-temporal feature information of a new access area of the candidate user within the first preset duration, and furthermore, by inputting feature information corresponding to the above-mentioned at least one candidate user into the trained preset classification model, it can be judged whether a target permanent area of the above-mentioned at least one candidate user is changed. As such, in this embodiment of the present application, by inputting, into the trained preset classification model, the determined feature information corresponding to the at least one candidate user whose permanent area may change, it can be judged whether a target permanent area of the above-mentioned at least one candidate user is changed, and thus it is possible to discover the change of the permanent area of the user quickly and accurately.

It should be understood that various forms of processes shown above can be used, and steps may be reordered, added, or deleted. For example, the steps described in the present application may be performed in parallel or sequentially or in different orders. As long as desired results of the technical solutions disclosed in the present application can be achieved, no limitation is made herein.

The above specific embodiments do not constitute a limitation to the protection scope of the present application. Persons skilled in the art should know that various modifications, combinations, sub-combinations and substitutions can be made according to design requirements and other factors. Any modification, equivalent replacement and improvement made within the spirit and principle of the present application shall be included in the protection scope of the present application.

What is claimed is:

1. A method for judging permanent area change, comprising:
determining feature information corresponding to at least one candidate user; wherein the candidate user is a user whose permanent area changes with a probability greater than a first preset probability threshold, and the feature information corresponding to the candidate user comprises: feature information of a first access behavior of the candidate user within a first preset duration, feature information of a second access behavior of the candidate user within a second preset duration, and spatio-temporal feature information of a new access area of the candidate user within the first preset duration; and
inputting the feature information corresponding to the at least one candidate user into a preset classification model to judge whether a target permanent area of the at least one candidate user is changed.

2. The method according to claim 1, wherein the determining feature information corresponding to at least one candidate user comprises:
for any candidate user, determining the feature information of the first access behavior and the feature information of the second access behavior according to location positioning information of the candidate user; and
determining the spatio-temporal feature information according to the location positioning information of the candidate user, map information, and demographic information.

3. The method according to claim 1, wherein before the determining feature information corresponding to at least one candidate user, the method further comprises:
determining a candidate set from an initial set based on probability distribution of a user accessing a permanent area; wherein the initial set comprises: user information of multiple users and at least one piece of permanent area information corresponding to the user information, and the candidate set comprises: user information of the at least one candidate user and at least one piece of permanent area information corresponding to the user information.

4. The method according to claim 3, wherein the determining a candidate set from an initial set based on probability distribution of a user accessing a permanent area comprises:
for any permanent area of any user in the initial set, determining a preset duration threshold corresponding to the user according to the probability distribution of the user accessing the permanent area and a second preset probability threshold; and
when the user does not access the permanent area corresponding to the user within the preset duration threshold, storing user information of the user and permanent area information corresponding to the permanent area into the candidate set.

5. The method according to claim 1, wherein before the inputting the feature information corresponding to the at least one candidate user into a preset classification model to judge whether a target permanent area of the at least one candidate user is changed, the method further comprises:
acquiring training data; wherein the training data comprises: feature information corresponding to multiple preset users, and indication information about whether a permanent area corresponding to each of the preset users is changed; and
inputting the training data into an initial classification model for training to obtain the preset classification model.

6. The method according claim 1, wherein the feature information of the first access behavior comprises at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or
the feature information of the second access behavior comprises at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or
the spatio-temporal feature information comprises at least one of the following: permanent population data of the new access area, a function category of the new access area, a number of points of interest (POI), and category distribution of the POI.

7. An apparatus for judging permanent area change, comprising:
at least one processor; and a memory communicatively connected to the at least one processor; wherein the memory is stored with instructions executable by the at least one processor, and the instructions are executed by the at least one processor to enable the at least one processor to:
determine feature information corresponding to at least one candidate user; wherein the candidate user is a user whose permanent area changes with a probability greater than a first preset probability threshold, and the feature information corresponding to the candidate user comprises: feature information of a first access behavior of the candidate user within a first preset duration, feature information of a second access behavior of the candidate user within a second preset duration, and spatio-temporal feature information of a new access area of the candidate user within the first preset duration; and
input the feature information corresponding to the at least one candidate user into a preset classification model to judge whether a target permanent area of the at least one candidate user is changed.

8. The apparatus according to claim 7, wherein the at least one processor is further configured to:
for any candidate user, determine the feature information of the first access behavior and the feature information of the second access behavior according to location positioning information of the candidate user; and
determine the spatio-temporal feature information according to the location positioning information of the candidate user, map information, and demographic information.

9. The apparatus according to claim 7, wherein the at least one processor is further configured to:
determine a candidate set from an initial set based on probability distribution of a user accessing a permanent area; wherein the initial set comprises: user information of multiple users and at least one piece of permanent area information corresponding to the user information, and the candidate set comprises: user information of the at least one candidate user and at least one piece of permanent area information corresponding to the user information.

10. The apparatus according to claim 9, wherein the at least one processor is further configured to:
for any permanent area of any user in the initial set, determine a preset duration threshold corresponding to the user according to the probability distribution of the user accessing the permanent area and a second preset probability threshold; and
when the user does not access the permanent area corresponding to the user within the preset duration threshold, store user information of the user and permanent area information corresponding to the permanent area into the candidate set.

11. The apparatus according to claim 7, wherein the at least one processor is further configured to:
acquire training data; wherein the training data comprises: feature information corresponding to multiple preset users, and indication information about whether a permanent area corresponding to the preset user is changed; and
input the training data into an initial classification model for training to obtain the preset classification model.

12. The apparatus according to claim 7, wherein the feature information of the first access behavior comprises at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or
the feature information of the second access behavior comprises at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or
the spatio-temporal feature information comprises at least one of the following: permanent population data of the new access area, a function category of the new access area, a number of points of interest (POI), and category distribution of the POIs.

13. A non-transitory computer readable storage medium stored with computer instructions, wherein the computer instructions are configured to enable a computer to execute the following steps:
determining feature information corresponding to at least one candidate user; wherein the candidate user is a user whose permanent area changes with a probability greater than a first preset probability threshold, and the feature information corresponding to the candidate user comprises: feature information of a first access behavior of the candidate user within a first preset duration, feature information of a second access behavior of the candidate user within a second preset duration, and spatio-temporal feature information of a new access area of the candidate user within the first preset duration; and
inputting the feature information corresponding to the at least one candidate user into a preset classification model to judge whether a target permanent area of the at least one candidate user is changed.

14. The non-transitory computer readable storage medium according to claim 13, wherein the computer instructions are further configured to enable the computer to execute the following steps:
for any candidate user, determining the feature information of the first access behavior and the feature information of the second access behavior according to location positioning information of the candidate user; and
determining the spatio-temporal feature information according to the location positioning information of the candidate user, map information, and demographic information.

15. The non-transitory computer readable storage medium according to claim 13, wherein the computer instructions are further configured to enable the computer to execute the following step:
determining a candidate set from an initial set based on probability distribution of a user accessing a permanent area; wherein the initial set comprises: user information of multiple users and at least one piece of permanent area information corresponding to the user information, and the candidate set comprises: user information of the at least one candidate user and at least one piece of permanent area information corresponding to the user information.

16. The non-transitory computer readable storage medium according to claim 15, wherein the computer instructions are further configured to enable the computer to execute the following steps:
for any permanent area of any user in the initial set, determining a preset duration threshold corresponding to the user according to the probability distribution of the user accessing the permanent area and a second preset probability threshold; and
when the user does not access the permanent area corresponding to the user within the preset duration threshold, storing user information of the user and permanent area information corresponding to the permanent area into the candidate set.

17. The non-transitory computer readable storage medium according to claim 13, wherein the computer instructions are further configured to enable the computer to execute the following steps:
acquiring training data; wherein the training data comprises: feature information corresponding to multiple preset users, and indication information about whether a permanent area corresponding to each of the preset users is changed; and
inputting the training data into an initial classification model for training to obtain the preset classification model.

18. The non-transitory computer readable storage medium according to claim 13, wherein the feature information of the first access behavior comprises at least one of the following: a daily average number of positioning points of the candidate user within the first preset duration, a number of positioning points of the candidate user within each first preset time period in the first preset duration, a frequency at which the candidate user accesses a further permanent area other than the target permanent area within the first preset duration, and a time during which the candidate user accesses the further permanent area within the first preset duration; and/or
the feature information of the second access behavior comprises at least one of the following: a daily average number of positioning points of the candidate user within the second preset duration, a number of positioning points of the candidate user within each second preset time period in the second preset duration, a frequency at which the candidate user accesses each permanent area within the second preset duration, and a time during which the candidate user accesses each permanent area within the second preset duration; and/or
the spatio-temporal feature information comprises at least one of the following: permanent population data of the new access area, a function category of the new access area, a number of points of interest (POI), and category distribution of the POI.
